(19) United States
(12) Patent Application Publication
(10) Pub. No.: US 2023/0223536 A1
(43) Pub. Date: Jul. 13, 2023

(54) NEGATIVE ELECTRODE ACTIVE MATERIAL, METHOD FOR PRODUCING THE SAME, AND LITHIUM ION SECONDARY BATTERY USING THE SAME

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yoshinori KUDO, Toyohashi-shi (JP); Hiroki NAKAFUJI, Toyohashi-shi (JP)

(21) Appl. No.: 18/074,514

(22) Filed: Dec. 5, 2022

(30) Foreign Application Priority Data
Dec. 6, 2021 (JP) 2021-198013

(51) Int. Cl. H01M 4/583; H01M 4/62; H01M 10/0525

(52) U.S. Cl. CPC H01M 4/583; H01M 4/625; H01M 10/0525; H01M 2004/027

(57) ABSTRACT

A method for producing a negative electrode active material realizing both of improvement in tolerance against the deposition of lithium and improvement in life performance is provided. A method for producing a negative electrode active material includes the steps of preparing graphite particles having a BET specific surface area of 10.3 m²/g or larger and 12.2 m²/g or smaller; and coating at least a part of a surface of the graphite particles with amorphous carbon. In the step of coating, at least the part of the surface of the graphite particles is coated with the amorphous carbon such that a value obtained by subtracting a BET specific surface area of the negative electrode active material from a BET specific surface area of the graphite particles is 6.9 m²/g or larger and 8.3 m²/g or smaller.

### CROSS REFERENCE TO RELATED APPLICATIONS

The present application claims priority from Japanese Patent Application No. 2021-198013 filed on Dec. 6, 2021, which is incorporated by reference herein in its entirety.

### BACKGROUND

The present disclosure relates to a negative electrode active material, a method for producing the same, and a lithium ion secondary battery using the same.

A secondary battery such as a lithium ion secondary battery or the like is lightweight and provides a high energy density, and therefore, is preferably used as a driving output source for vehicles such as electric vehicles, hybrid electric vehicles and the like, and demand therefor is expected to rise significantly in the future.

Typically, a negative electrode of such a lithium ion secondary battery includes a negative electrode active material. As the negative electrode active material, for example, graphite is used. Graphite has a graphite structure and occludes many lithium ions, and therefore, is preferably used as a negative electrode active material of a lithium ion secondary battery. For example, WO2019/031543 discloses a negative electrode active material containing flake artificial graphite and vein artificial graphite. It is described that in the case where by appropriately adjusting a ratio of average particle diameters D₅₀, a surface roughness and a mass ratio thereof, a negative electrode active material that is capable of realizing a secondary battery having superb charge rate characteristics at a large capacity and a high current density and having a superb capacity maintaining ratio after being stored at a high temperature is provided. For example, Japanese Laid-Open Patent Publication No. 2001-135356, Japanese Laid-Open Patent Publication No. 2011-233541, Japanese Laid-Open Patent Publication No. 2017-142932 and WO2020/110943 disclose structures of negative electrode active materials, for lithium ion secondary battery, containing various types of graphite.

### SUMMARY

In a lithium ion secondary battery including graphite as a negative electrode active material, in the case where graphite has an insufficient lithium ion acceptability, lithium ions may not be sufficiently occluded and as a result, lithium may be deposited. Such deposition of lithium decreases the ion concentration in an electrolyte solution, and the deposited lithium is attached to a surface the graphite to increase the reaction resistance, which are not preferred. In order to improve the lithium ion acceptability of the graphite, the BET specific surface thereof area may be increased. However, this tends to deteriorate life performance. There is a problem that such deteriorated life performance lowers the performance of the battery, for example, increases the reaction resistance of the lithium ion secondary battery.

The present disclosure, made in light of such a situation, has a main object of providing a negative electrode active material realizing both of improvement in tolerance against deposition of lithium and improvement in life performance. Another object of the present disclosure is to provide a lithium ion secondary battery including such a negative electrode active material. Still another object of the present disclosure is to provide a method for producing such a negative electrode active material.

The present disclosure provides a method for producing a negative electrode active material containing amorphous carbon-coated graphite particles including graphite particles and amorphous carbon coating at least a part of a surface thereof. The method for producing the negative electrode active material disclosed therein includes the steps of preparing the graphite particles having a BET specific surface area of 10.3 m²/g or larger and 12.2 m²/g or smaller; and coating at least a part of the surface of the graphite particles with the amorphous carbon. In the step of coating, at least the part of the surface of the graphite particles is coated with the amorphous carbon such that a value obtained by subtracting a BET specific surface area of the negative electrode active material from a BET specific surface area of the graphite particles is 6.9 m²/g or larger and 8.3 m²/g or smaller.

According to such a structure, a surface of the graphite having a large BET specific surface area and a high lithium ion acceptability is appropriately coated with the amorphous carbon, which does not easily cause the decomposition reaction of the electrolyte solution. This provides both of a high lithium ion acceptability and suppression of the decomposition of the electrolyte solution. As a result, a negative electrode active material realizing both of improvement in the tolerance against the deposition of lithium and improvement in the life performance is provided.

In an embodiment of the method for producing the negative electrode active material disclosed herein, the negative electrode active material has an average particle diameter (D₅₀), based on a volume-based particle diameter distribution by a laser diffraction and scattering method, of 7.2 μm or longer and 9.1 μm or shorter. According to such a structure, a negative electrode active material realizing improvement in the tolerance against the deposition of lithium and improvement in the life performance both at a high level is provided.

The present disclosure provides a negative electrode active material usable for a lithium ion secondary battery. The negative electrode active material disclosed herein includes amorphous carbon-coated graphite particles having a surface, at least a part of which is coated with amorphous carbon. The negative electrode active material has an average particle diameter (D₅₀), based on a volume-based particle diameter distribution by a laser diffraction and scattering method, of 7.2 μm or longer and 9.1 μm or shorter. The negative electrode active material has a BET specific surface area of 3.4 m²/g or larger and 4.5 m²/g or smaller. In a Raman spectrum measured by laser Raman spectroscopy, an intensity ratio (I_{D}/I_{G}) of an intensity I_{D} of a D peak appearing at a position of 1470 cm⁻¹ with respect to an intensity I_{G} of a G peak appearing at a position of 1580 cm⁻¹ is 0.15 or higher and 0.23 or lower. According to such a structure, a negative electrode active material realizing both of improvement in the tolerance against the deposition of lithium and improvement in the life performance is provided.

In an embodiment of the negative electrode active material disclosed herein, the graphite particles are formed of natural graphite. The natural graphite has a high graphite crystallinity and a high lithium ion acceptability. Therefore, the tolerance against the deposition of lithium is preferably improved.

The present disclosure provides a lithium ion secondary battery. The lithium ion secondary battery disclosed herein includes a positive electrode, a negative electrode, and a non-aqueous electrolyte. The negative electrode includes a negative electrode active material disclosed herein. According to such a structure, a lithium ion secondary battery realizing both of improvement in the tolerance against the deposition of lithium and improvement in the life performance is provided.

### BRIEF DESCRIPTION OF THE DRAWINGS

FIG. 1 is a cross-sectional view schematically showing a structure of a lithium ion secondary battery according to an embodiment.

FIG. 2 is an exploded view schematically showing a structure of an electrode assembly of the lithium ion secondary battery according to an embodiment.

FIG. 3 is a schematic view showing a structure of an amorphous carbon-coated graphite particle contained in a negative electrode active material according to an embodiment.

FIG. 4 is a rough flowchart illustrating a process for producing of the negative electrode active material according to an embodiment.

FIG. 5 is a graph showing the relationship between the difference between the BET specific surface area of the negative electrode active material and the BET specific surface area of the graphite (ABET specific surface area) and the reaction resistance ratio.

### DETAILED DESCRIPTION

Hereinafter, a technology disclosed herein will be described. A matter that is other than a matter specifically referred to in this specification but is necessary to carry out the technology disclosed herein may be understood as a matter of design for a person of ordinary skill in the art based on the conventional technology in the art. Contents of the technology disclosed herein may be carried out based on contents disclosed herein and the technological common knowledge in the art.

The drawings are drawn schematically, and the relationship between sizes (length, width, thickness, etc.) does not necessarily reflect the actual relationship between sizes. In the drawings referred to below, components or portions having the same functions will bear the same reference signs, and overlapping descriptions may be omitted or simplified.

In this specification, a numerical range described as “A to B” refers to, as generally understood, “A or more and B or less”, and encompasses a range of “more than A and less than B”.

In this specification, the term “secondary battery” refers to an electric power storage device in general in which a charge carrier moves between a pair of electrodes (a positive electrode and a negative electrode) via an electrolyte to cause a charge and discharge reaction. Such a secondary battery encompasses so-called storage battery and also encompasses capacitors such as an electric double layer capacitor and the like. In this specification, the term “lithium ion secondary battery” refers to a secondary battery that uses lithium ions as a charge carrier and realizes charge and discharge by movement of charges, accompanying lithium ions, between the positive electrode and the negative electrode.

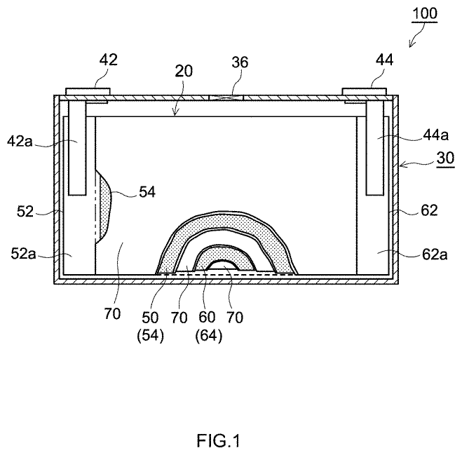

Hereinafter, an embodiment of a lithium ion secondary battery disclosed herein will be described. FIG. 1 is a cross-sectional view schematically showing a structure of a lithium ion secondary battery 100 according to an embodiment. The lithium ion secondary battery 100 is a quadrangular sealed battery including a flat electrode assembly (rolled electrode assembly) 20 and a non-aqueous electrolyte (not shown) accommodated in a battery case 30. The battery case 30 is provided with a positive electrode terminal 42 and a negative electrode terminal 44 both for connection with an external device. The battery case 30 is also provided with a thin safety valve 36, which is set to release an inner pressure of the battery case 30 in the case where the inner pressure is raised to a predetermined level or higher. The battery case 30 also includes a liquid injection opening (not shown) through which the non-aqueous electrolyte is to be injected. The battery case 30 is preferably formed of a metal material that is highly strong, lightweight and has a high thermal conductivity. Examples of such a metal material include aluminum, steel and the like.

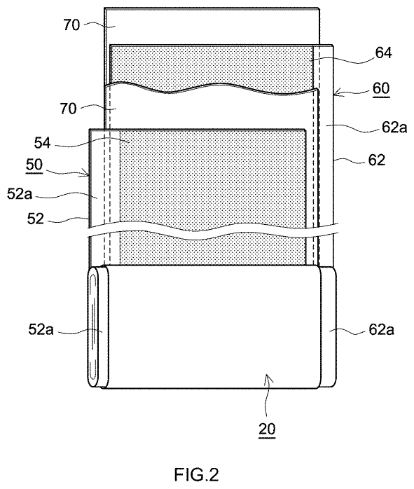

FIG. 2 is an exploded view schematically showing a structure of the electrode assembly 20 of the lithium ion secondary battery 100. As shown in FIG. 2, the electrode assembly 20 is a wound electrode assembly in which an elongated positive electrode 50 and an elongated negative electrode 60 are stacked on each other, with two elongated separators 70 being sandwiched between the positive electrode 50 and the negative electrode 60, and are wound about a winding axis. The positive electrode 50 includes a positive electrode current collector 52 and a positive electrode active material layer 54 formed on one surface of, or both of two surfaces of, the positive electrode current collector 52 (in this example, formed on both of two surfaces of the positive electrode current collector 52) in a longitudinal direction. The positive electrode current collector 52 includes a strip-like portion in which the positive electrode active material layer 54 is not formed and the positive electrode current collector 52 is exposed (i.e., a positive electrode current collector exposed portion 52a), along an edge in a winding axis direction (i.e., a sheet width direction perpendicular to the longitudinal direction). The negative electrode 60 includes a negative electrode current collector 62 and a negative electrode active material layer 64 formed on one surface of, or both of two surfaces of, the negative electrode current collector 62 (in this example, formed on both of two surfaces of the positive electrode current collector 62) in the longitudinal direction. The negative electrode current collector 62 includes a strip-like portion in which the negative electrode active material layer 64 is not formed and the negative electrode current collector 62 is exposed (i.e., a negative electrode current collector exposed portion 62a), along an edge opposite to the above-mentioned edge in the winding axis direction. The positive electrode current collector exposed portion 52a is joined with a positive electrode current collector 42a, and the negative electrode current collector exposed portion 62a is joined with a negative electrode current collector 44a (see FIG. 1). The positive electrode current collector 42a is electrically connected with the positive electrode terminal 42 for connection with an external device, and realizes electric connection between the inside and the outside of the battery case 30. Similarly, the negative electrode current collector 44a is electrically connected with the negative electrode terminal 44 for connection with an external device, and realizes electric connection between the inside and the outside of the battery case 30 (see FIG. 1). A current interrupt device (CID) may be provided between the positive electrode terminal 42 and the positive electrode current collector 42a, or between the negative electrode terminal 44 and the negative electrode current collector 44a.

The positive electrode current collector 52 included in the positive electrode 50 is, for example, an aluminum foil. The positive electrode active material included in the positive electrode active material layer 54 is, for example, a lithium composite metal oxide having a layer structure, a spinel structure or the like (e.g., LiNi_{1/3}Co_{1/3}Mn_{1/3}O₂, LiNiO₂, LiCoO₂, LiFeO₂, LiMn₂O₄, LiNi_{0.5}Mn_{1.5}O₄, LiCrMnO₄, LiFePO₄, etc.). The positive electrode active material layer 54 may include a conductive material, a binder or the like. As the conductive material, for example, carbon black such as acetylene black (AB) or the like, or another carbon material (graphite, etc.) is preferably usable. As the binder, for example, poly(vinylidene fluoride) (PVDF) or the like is usable.

The positive electrode active material layer 54 may be formed as follows. The positive electrode active material and a material used as necessary (the conductive material, the binder or the like) are dispersed in an appropriate solvent (e.g., N-methyl-2-pyrrolidone (NMP)) to prepare a paste (or slurry) composition, and an appropriate amount of the composition is applied to a surface of the positive electrode current collector 52 and is dried.

The negative electrode current collector 62 included in the negative electrode 60 is, for example, a copper foil or the like. The negative electrode active material layer 64 includes a negative electrode active material disclosed herein. The negative electrode active material will be described below in detail. The negative electrode active material layer 64 may further include a binder, a thickener or the like. As the binder, for example, styrene butadiene rubber (SBR) or the like is usable. As the thickener, for example, carboxymethylcellulose (CMC) or the like is usable.

The negative electrode active material layer 64 may be formed as follows, for example. The negative electrode active material and a material used as necessary (the binder or the like) are dispersed in an appropriate solvent (e.g., ion exchange water) to prepare a paste (or slurry) composition, and an appropriate amount of the composition is applied to a surface of the negative electrode current collector 62 and is dried.

As the separator 70, any of various types of microporous sheets substantially the same to those conventionally used for a lithium ion secondary battery is usable. For example, a microporous resin sheet formed of a resin such as polyethylene (PE), polypropylene (PP) or the like is usable. Such a microporous resin sheet may have a single-layer structure or a multi-layer structure including two or more layers (e.g., a three-layer structure including a PE layer and PP layers stacked on both of two surfaces of the PE layer). The separator 70 may include a heat resistant layer (HRL layer) formed at a surface thereof.

As the non-aqueous electrolyte, any of non-aqueous electrolytes substantially the same to those conventionally used for a lithium ion secondary battery is usable. For example, a non-aqueous electrolyte solution containing a support salt in an organic solvent (non-aqueous solvent) is usable. As the non-aqueous solvent, any of non-protic solvents such as carbonates, esters, ethers and the like is usable. Among these, a carbonate, for example, ethylenecarbonate (EC), diethylcarbonate (DEC), dimethylcarbonate (DMC), ethylmethylcarbonate (EMC) or the like is preferably usable. Alternatively, a fluorine-based solvent such as a carbonate fluride or the like, for example, monofluoroethylenecarbonate (MFEC), difluoroethylenecarbonate (DFEC), monofluoromethyldifluoromethylcarbonate (F-DMC), trifluorodimethylcarobnate (TFDMC) or the like is preferably usable. One of such non-aqueous solvents may be used independently, or two or more thereof may be used in combination appropriately. As the support salt, for example, a lithium salt such as LiPF₆, LiBF₄, LiClO₄ or the like is preferably usable. The support salt has a concentration that is preferably 0.7 mol/L or higher and 1.3 mol/L or lower, although there is no specific limitation on the concentration of the support salt.

The non-aqueous electrolyte may contain a component other than the non-aqueous solvent and the support salt as long as effects of the present technology are not significantly spoiled. For example, the non-aqueous electrolyte may contain any of various types of additives such as a gas generating agent, a coating agent, a dispersant, a thickener and the like. Specific examples of such additives include fluorophosphate (preferably, difluorophosphate, for example, lithium difluorophosphate expressed by LiPO₂F₂), and oxalate complex compounds such as lithiumbis(oxalate)borate (LiBOB) and the like.

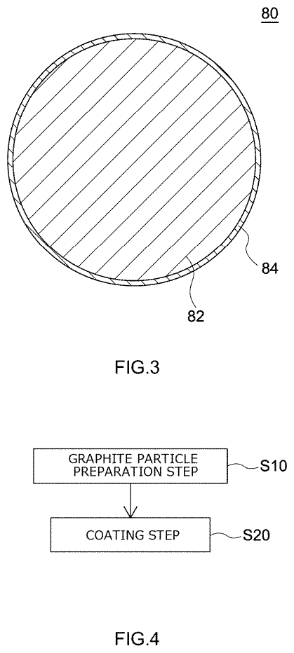

Hereinafter, the negative electrode active material disclosed herein will be described. The negative electrode active material disclosed herein contains amorphous carbon-coated graphite particles 80. FIG. 3 is a schematic view showing a structure of one amorphous carbon-coated graphite particle 80 according to an embodiment. The amorphous carbon-coated graphite particle 80 includes a graphite particle 82 as a core, and a coating layer 84 containing amorphous carbon is formed (disposed) on at least a part of a surface of the graphite particle 82.

The negative electrode active material disclosed herein contains the amorphous carbon-coated graphite particles 80 as a main component. With respect to all the particles contained in the negative electrode active material, the amorphous carbon-coated graphite particles 80 occupy typically 80% by mass or higher, preferably 90% by mass or higher, and more preferably 95% by mass or higher (e.g., 100% by mass).

In general, in the case where graphite particles have a BET specific surface area thereof increased, the graphite particles also have a lithium ion acceptability thereof improved, which improves the tolerance against the deposition of lithium. However, there is a trade-off relationship that such increase in the BET specific surface area increases the size of a contact area along which the graphite particles and the electrolyte solution contact each other, and therefore, the electrolyte solution is easily decomposed to deteriorate the life performance (e.g., reaction resistance). In such a situation, the present inventors conceived coating the surface of the graphite particles with amorphous carbon, which does not easily cause the decomposition reaction of the electrolyte solution, to appropriately adjust surface properties of the graphite particles and thus to improve the life performance, and made active studies. As a result, the prevent inventors have found out that in the case where graphite particles having a high BET specific surface area (e.g., a BET specific surface area of 10.3 m²/g or larger and 12.2 m²/g or smaller) are coated with amorous carbon and adjustment is made such that a value obtained by subtracting the BET specific surface area of the graphite particles coated with the amorphous carbon (negative electrode active material) from the BET specific surface area of the graphite particles (hereinafter, such a value will be referred to also as a “ABET specific surface area”) is in a predetermined range (e.g., 6.9 m²/g or larger and 8.3 m²/g or smaller), the tolerance against the deposition of lithium is improved while the life performance is improved. A reason for this is considered to be the following although the reason is not limited to the following mechanism. The graphite particles having a high BET specific surface area are used. Therefore, even if the coating of the amorphous carbon smooths convexed and concaved portions that may be present at the surface of the graphite particles, or closes microscopic holes that may be included in the graphite particles, and as a result, decreases the BET specific surface area, edge surfaces of the graphite particles, which contribute to the lithium ion acceptability, are kept exposed sufficiently as long as the amorphous carbon coating is of an appropriate amount. It is presumed that for this reason, the effect of improving the tolerance against the deposition of lithium and the effect of improving the life performance by the amorphous carbon coating are both provided.

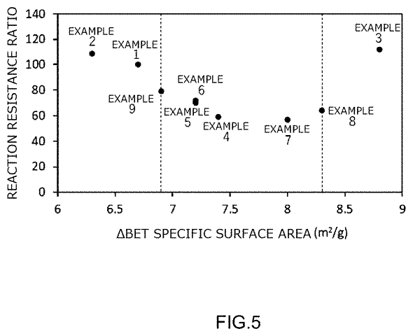

First, a method for producing the negative electrode active material disclosed herein will be described. FIG. 4 is a rough flowchart illustrating a process of producing the negative electrode active material according to an embodiment. The method for producing the negative electrode active material disclosed herein includes a step of preparing graphite particles (hereinafter, referred to as a “graphite particle preparation step S10) and a step of coating at least a part of a surface of the graphite particles with amorphous carbon (hereinafter, referred to as a “coating step S20”).

In the graphite particle preparation step S10, graphite particles acting as a core of the amorphous carbon-coated graphite particles 80 are prepared. As the graphite particles, for example, natural graphite, artificial graphite or the like is usable. Examples of the natural graphite include flake graphite, vein graphite and the like. Natural graphite has a higher graphite crystallinity and a higher lithium ion acceptability than those of artificial graphite, and therefore, is preferably usable. The graphite preferably has a generally spherical shape although there is no specific limitation on the shape thereof. In a preferred embodiment, natural graphite is processed by pulverization, sieving, pressing and the like to be generally spherical, and the obtained spherical natural graphite is used. In the case where the graphite particles are generally spherical, the BET specific surface area of the graphite particles is increased, and lithium ions are easily inserted between layers of a layer structure of the graphite. Therefore, the lithium ion acceptability is improved.

In this specification, the term “generally spherical” encompasses, for example, spherical, rugby ball-like and polygonal shapes, and refers to a shape having an average aspect ratio (regarding a smallest rectangle circumscribing a particle in an electronic microscopic image, the aspect ratio is the ratio of the length in a longer axis with respect to the length in a shorter axis) of generally 1 to 2, for example, 1 to 1.5.

The BET specific surface area of the graphite particles prepared herein may be, for example, 10.3 m²/g or larger, preferably 10.9 m²/g or larger, more preferably 11.2 m²/g or larger, and still more preferably 11.9 m²/g or larger from the point of view of improving the lithium ion acceptability. From the point of view of improving the durability of the negative electrode active material, the BET specific surface area of the graphite may be 12.2 m²/g or smaller, for example, 12 m²/g or smaller, although there is no specific limitation on the upper limit of the BET specific surface area of the graphite.

In this specification, the term “BET specific surface area” refers to a value obtained by analyzing a surface area, measured by a low-dose adsorption method performed by use of nitrogen gas (a so-called nitrogen gas adsorption method), with a BET method. For such analysis, for example, a commercially available specific surface area meter (e.g., “Macsorb Model-1208” (produced by Mountech Co., Ltd.), etc.) is usable.

The graphite particles prepared herein has an average particle diameter that may be, for example, 6 μm or longer or 7 μm or longer from the point of view of improving the durability, although there is no specific limitation on the average particle diameter. From the point of view of increasing the BET specific surface area of the graphite particles, the average particle diameter thereof may be, for example, 9 μm or shorter, 8 μm or shorter, or 7.5 μm or shorter.

In this specification, the term “average particle diameter” refers to a median diameter (D₅₀), namely, a particle diameter corresponding to a cumulative frequency of 50% by volume from the shorter particle diameter side in a volume-based particle diameter distribution based on a laser diffraction and scattering method. The average particle diameter (D₅₀) may be found by use of a commercially available laser diffraction and scattering-type particle diameter distribution meter or the like.

In the coating step S20, at least a part of the surface of the graphite particles is coated with the amorphous carbon. A conventionally known method is usable for coating the surface with the graphite particles. For example, a gas phase method such as a CVD (Chemical Vapor Deposition) method, a liquid phase method, a solid phase method or the like is usable. For example, amorphous carbon materials usable for the CVD method include various hydrocarbon compounds including unsaturated aliphatic hydrocarbons such as ethylene, acetylene, propylene and the like; saturated aliphatic hydrocarbons such as methane, ethane, propane and the like; and aromatic hydrocarbons such as benzene, toluene, naphthalene and the like.

Preferably, a liquid phase method or a solid phase method is usable as a method for coating the surface with the amorphous carbon. Such a method is performed as follows. First, the graphite particles and an amorphous carbon material are mixed. As the amorphous carbon material, a material that may be carbonized by firing is preferably usable. Examples of such a material include aromatic hydrocarbons such as naphthalene, anthracene and the like; pitch-based or tar-based materials containing, as a raw material, coal, petroleum, wood or the like; heavy oil; thermoplastic resins; thermosetting resins; and the like.

The amorphous carbon to coat the graphite particles may be provided in an amount that is controlled by the amount of the amorphous carbon material to be mixed. The amount of the amorphous carbon material to be mixed is appropriately adjusted in accordance with the size or the shape of the graphite particles, the type of the amorphous carbon material, or the like. Typically, the amorphous carbon material is contained at 2 parts by mass to 10 parts by mass, for example, 3 parts by mass to 8 parts by mass, with respect to 100 parts by mass of the graphite particles.

Next, the mixture of the graphic particles and the amorphous carbon material is fired to coat the surface of the graphic particles with the amorphous carbon. For the firing, for example, a batch firing furnace, a continuous firing furnace or the like is usable. It is preferred that the firing is performed in a non-oxidizing atmosphere, for example, an Ar atmosphere or an N₂ atmosphere. The firing may be performed at a temperature of, for example, 800° C. to 1600° C., although there is no specific limitation on the firing temperature. At such a firing temperature, the amorphous carbon material is carbonized in a preferred manner, and therefore, is allowed to coat the graphite particles in a preferred manner. The firing may be performed for a time period of, typically, 1 hour to 20 hours, for example, 3 hours to 7 hours, although there is no specific limitation on the firing time period.

As a result of being coated with the amorphous carbon in this manner, the surface of the graphite particles is smoothed, and the microscopic holes that may be included in the graphite particles are closed. Therefore, typically, the BET specific surface area of the amorphous carbon-coated graphite particles is smaller than the BET specific surface area of the graphite particles (the graphite particles before coating the amorphous carbon). If the value obtained by subtracting the BET specific surface area of the amorphous carbon-coated graphite particles (negative electrode active material) from the BET specific surface area of the graphite particles, i.e., the ABET specific surface area, is too small, the graphite particles are not sufficiently coated with the amorphous carbon. In this case, the electrolyte solution is easily decomposed, and as a result, the life of the negative electrode active material is undesirably shortened. Therefore, the ABET specific surface area may be, for example, 6.9 m²/g or larger, preferably 7.2 m²/g or larger, and more preferably 7.4 m²/g. If the ABET specific surface area is too large, the graphite particles are excessively coated with the amorphous carbon. In this case, the lithium ion acceptability of the negative electrode active material is insufficient, and as a result, the lithium is undesirably deposited easily. Therefore, the ABET specific surface area may be, for example, 8.3 m²/g or smaller, and preferably 8 m²/g or smaller. The ABET specific surface area may be adjusted by, for example, the amount of the amorphous carbon material mixed in the coating step S20.

The negative electrode active material containing the amorphous carbon-coated graphite particles 80 disclosed herein is produced by this method. The BET specific surface area of the negative electrode active material disclosed herein is, for example, 3.4 m²/g or larger, preferably 3.7 m²/g or larger, and more preferably 3.9 m²/g or larger. With such a BET specific surface area, the lithium ion acceptability is improved, and the deposition of lithium is suppressed. The BET specific surface area of the negative electrode active material is, for example, 4.5 m²/g or smaller, and preferably 4.2 m²/g or smaller. With such a BET specific surface area, the progress of the decomposition of the electrolyte solution is suppressed, and the life performance is improved.

The average particle diameter (D₅₀) of the negative electrode active material disclosed herein is, for example, 7.2 μm to 9.1 μm, preferably 7.2 μm to 8.3 μm, and more preferably 7.2 μm to 8 μm. With such an average particle diameter, the improvement in the tolerance against the deposition of lithium and the improvement in the life performance are realized both at a high level.

The amount of the coating layer 84 of the amorphous carbon-coated graphite particles 80 contained in the negative electrode active material disclosed herein may be evaluated by, for example, Raman spectrum analysis. For example, the Raman spectrum of the negative electrode active material may be measured by laser Raman spectroscopy using, for example, appropriate laser light (e.g., argon laser ion laser light) as a light source. Where in this Raman spectrum, the intensity of the D peak appearing at the position of 1470 cm⁻¹ is I_{D}, and the intensity of the G peak appearing at the position of 1580 cm⁻¹ is I_{G}, the intensity ratio (I_{D}/I_{G}) may be 1.15 or higher, for example, 0.17 or higher or 0.19 or higher. The intensity ratio (I_{D}/I_{G}) may be 0.23 or lower, for example, 0.22 or lower. The intensity ratio (I_{D}/I_{G}) is the ratio of the intensity I_{D} of the D peak, which reflects an irregular structure, with respect to the intensity I_{G} of the G peak, which reflects a regular graphite structure. Therefore, there is a tendency that as the amount of the amorphous carbon coating the graphite particles is larger, the intensity ratio (I_{D}/I_{G}) is larger. Regarding the negative electrode active material disclosed herein, in the case where the intensity ratio (I_{D}/I_{G}) is in the above-described range, the graphite particles 82 are coated with the amorphous carbon at an appropriate degree. In this case, the improvement in the tolerance against the deposition of lithium and the improvement in the life performance are both realized in a preferred manner. The upper limit and the lower limit of the intensity ratio (I_{D}/I_{G}) may be combined arbitrarily.

The negative electrode active material and the lithium ion secondary battery 100 according to an embodiment have been described. The negative electrode active material disclosed herein is preferably used in the lithium ion secondary battery 100, so that the lithium ion secondary battery realizes both of improvement in the tolerance against the deposition of lithium and improvement in the life performance. The lithium ion secondary battery 100 is usable for any of various uses. Specific uses include driving power sources for vehicles such as for battery electric vehicles (BEVs), hybrid electric vehicles (HEVs), plug-in hybrid electric vehicles (PHEVs), and the like; and a storage battery of compact power storage devices, and the like. Among these uses, the driving power sources for vehicles are preferred. The lithium ion secondary battery 100 is also typically used in the form of an assembly battery in which plural lithium ion secondary batteries (cells) 100 are connected in series and/or in parallel.

In the above embodiment, the quadrangular lithium ion secondary battery 100 including the flat wound electrode assembly 20 is described. Alternatively, the lithium ion secondary battery disclosed herein may be structured as a lithium ion secondary battery including a stacked electrode assembly (i.e., an electrode assembly including plural positive electrodes and plural negative electrodes stacked alternately).

The lithium ion secondary battery disclosed herein may be structured as a coin-shaped lithium ion secondary battery, a button-shaped lithium ion secondary battery, a cylindrical lithium ion secondary battery, or a laminated case-shaped lithium ion secondary battery. The lithium ion secondary battery disclosed herein may be a polymer secondary battery using a polymer electrolyte instead of the non-aqueous electrolyte solution, an all-solid-state secondary battery using a solid electrolyte instead of the non-aqueous electrolyte solution, or the like.

Hereinafter, examples of the technology disclosed herein will be described. It is not intended that the technology disclosed herein is limited to any of the examples.

### <Production of a Negative Electrode Active Material>

For producing a negative electrode active material in each of examples 1 through 9, natural graphite put into a spherical shape and heavy oil as an amorphous carbon material (coating material) were prepared. Next, 3 to 8 parts by weight of the heavy oil was mixed in 100 parts by weight of the natural graphite to immerse the natural graphite in the heavy oil. Then, the natural graphite provided with the heavy oil was fired at 800° C. to 1600° C. for 3 to 7 hours in a non-oxidizing atmosphere. As a result, graphite having a surface coated with the amorphous carbon (amorphous carbon-coated graphite) was obtained as the negative electrode active material. The amount of the amorphous carbon was adjusted in accordance with the amount of the heavy oil.

### <Measurement of the BET Specific Surface Area>

The BET specific surface areas of the natural graphite and the negative electrode active material (amorphous carbon-coated graphite) in each of examples 1 through 9 were measured. First, the natural graphite or the negative electrode active material as a sample to be measured was put into a sample tube in an amount of 0.8 g to 1.3 g, and heated at 300° C. for 1 hour. Then, the measurement was performed in an N₂ atmosphere at 77 K. From the obtained adsorption isotherm and the weight of the sample, the BET specific surface area (m²/g) was calculated. The results are shown in Table 1. The difference between the BET specific surface area of the negative electrode active material and the BET specific surface area of the natural graphite is shown as the “ABET specific surface area (m²/g)”.

### <Measurement of the Average Particle Diameter>

The average particle diameter of the negative electrode active material (amorphous carbon-coated graphite) in each of examples 1 through 9 was measured by use of a commercially available laser diffraction and scattering-type particle diameter distribution meter. The particle diameter corresponding to the cumulative frequency of 50% by volume from the shorter particle diameter side was found as the average particle diameter (D₅₀) of the negative electrode active material. The results are shown in Table 1.

### <Raman Spectrum Measurement>

The Raman spectrum of the negative electrode active material (amorphous carbon-coated graphite) in each of examples 2 through 9 was obtained by a commercially available laser Raman microprobe analyzer. Such analysis was performed using Nd:YVO4 laser as a light source, under the conditions of an exposure time of 20 seconds, a cumulate time of 2, and an observation magnification of 100. Where the peak intensity at 1470 cm⁻¹ of the obtained Raman spectrum was I_{D} and the peak intensity at 1580 cm⁻¹ of the obtained Raman spectrum was I_{G}, the Raman peak intensity ratio (I_{D}/I_{G}) was calculated. Such analysis was performed 30 times in each example. The average value of the Raman peak intensity ratio (I_{D}/I_{G}) in each example is shown in Table 1.

### <Production of a Negative Electrode Sheet>

In each of examples 1 through 9, the negative electrode active material produced above, styrene butadiene rubber (SBR) as the binder, and carboxymethylcellulose (CMC) as the thickener were mixed such that the weight ratio would be negative electrode active material:binder:thickener=98:1:1. An appropriate amount of ion exchange water was incorporated as a solvent. As a result, a slurry for formation of a negative electrode active material was prepared. The slurry for formation of a negative electrode active material was applied to the negative electrode current collector formed of copper foil such that a weight per unit area of 7 mg/cm² would be obtained. Then, the obtained item was dried and pressed by a roll, and a negative electrode sheet was produced.

### <Production of a Positive Electrode Sheet>

Lithium nickel cobalt manganese composite oxide (NiLi_{1/3}Co_{1/3}Mn_{1/3}O₂) as the positive electrode active material, acetylene black (AB) as the conductive material, poly(vinylidene fluoride) (PVdF) as the binder were mixed such that the ratio would be positive electrode active material:conductive material:binder=91:6:3. An appropriate amount of N-methyl-2-pyrrolidone (NMP) was incorporated as a solvent. As a result, a slurry for formation of a positive electrode active material was prepared. The slurry for formation of a positive electrode active material was applied to the positive electrode current collector formed of aluminum foil such that a weight per unit area of 10 mg/cm² would be obtained. Then, the obtained item was dried and pressed by a roll, and a positive electrode sheet was produced.

As the separator, a microporous polyolefin sheet having a three-layer structure of PP/PE/PP and having a thickness of 18 μm was prepared. The positive electrode sheet and the negative electrode sheet were stacked such that the separator would be sandwiched between the sheets. In this manner, a stacked electrode assembly was obtained.

Next, current collectors were welded to the stacked electrode assembly, the obtained stacked electrode assembly was accommodated in a laminated film, and a non-aqueous electrolyte solution was injected. For preparing the non-aqueous electrolyte solution, ethylenecarbonate (EC), ethylmethylcarbonate (EMC) and dimethylcarbonate (DMC) were mixed at a volume ratio of EC:EMC:DMC=30:35:35 to prepare a mixed solvent, LiPF₆ as the support salt was dissolved in the mixed solvent at a concentration of 1.1 mol/L, and then LiBOB as an additive was incorporated at a content of 0.5% by mass.

Then, the stacked electrode assembly was sealed with the laminated film to produce a lithium ion secondary battery for evaluation.

### <Initial Charge and Aging>

The lithium ion secondary battery for evaluation was subjected to initial charge, specifically, was charged with a constant current of a value of 1 C in an environment of 25° C. up to 4.1 V so as to have an SOC (state of charge) of 100% (so as to be fully charged). Next, the lithium ion secondary battery for evaluation was subjected to aging, specifically, was held at 60° C. for 2 hours. Herein, “1 C” refers to a level of the current by which the SOC (state of charge) is increased from 0% to 100% in 1 hour.

### <Measurement of the Reaction Resistance>

The SOC of the lithium ion secondary battery for evaluation was adjusted to 60%, and an AC impedance measurement was performed at a measuring temperature of −10° C., a measuring frequency range of 0.01 Hz to 100000 Hz, and a current amplitude of 0.2 C. The charge transfer resistance (Rct) calculated from equivalent circuit fitting of a Cole-Cole plot was set as the reaction resistance. Table 1 shows the relative value (reaction resistance ratio) with respect to the reaction resistance ratio in example 1, which is set as 100. FIG. 5 is a graph showing the relationship between the ABET specific surface area (m²/g) and the reaction resistance ratio.

TABLE 1

| | NEGATIVE | NEGATIVE | | | | |
|---|---|---|---|---|---|---|
| | ELECTRODE | ELECTRODE | | | | |
| | ACTIVE MATERIAL | ACTIVE MATERIAL | GRAPHITE | | | RAMAN PEAK |
| | AVERAGE PARTICLE | BET SPECIFIC | BET SPECIFIC | ΔBET SPECIFIC | | INTENSITY |
| | DIAMETER D₅₀ | SURFACE AREA | SURFACE AREA | SURFACE AREA | REACTION | RATIO |
| | (μm) | (m²/g) | (m²/g) | (m²/g) | RESISTANCE | I_{D}/I_{G} |
| EXAMPLE 1 | 10.3 | 4.3 | 11 | 6.7 | 100 | — |
| EXAMPLE 2 | 9.6 | 3.5 | 9.8 | 6.3 | 109 | 0.17 |
| EXAMPLE 3 | 7.4 | 3.7 | 12.5 | 8.8 | 112 | 0.26 |
| EXAMPLE 4 | 8 | 4.5 | 11.9 | 7.4 | 59 | 0.19 |
| EXAMPLE 5 | 8 | 4 | 11.2 | 7.2 | 70 | 0.15 |
| EXAMPLE 6 | 8.3 | 3.7 | 10.9 | 7.2 | 72 | 0.22 |
| EXAMPLE 7 | 7.2 | 4.2 | 12.2 | 8 | 57 | 0.22 |
| EXAMPLE 8 | 7.3 | 3.9 | 12.2 | 8.3 | 64 | 0.23 |
| EXAMPLE 9 | 9.1 | 3.4 | 10.3 | 6.9 | 79 | 0.17 |

“—” indicates that the value is not determined.

As shown in Table 1 and FIG. 5, in examples 4 through 9, the reaction resistance is lower than in example 1. In examples 2 and 3, the reaction resistance is higher than in example 1. As can be seen from FIG. 5, in the case where the ABET specific surface area is 6.9 m²/g or larger and 8.3 m²/g or smaller, the reaction resistance is decreased. It is seen that in the case where the ABET specific surface area is preferably 7.2 m²/g or larger and 8.3 m²/g or smaller, and more preferably 7.4 m²/g or larger and 8.3 m²/g or smaller, the reaction resistance is especially decreased. A reason for these results is presumed to be the following although the reason is not limited thereto. In examples 1 and 2, the ABET specific surface area was relatively small. Namely, it is considered that in examples 1 and 2, the surface of the graphite was not sufficiently coated with the amorphous carbon. It is presumed that as a result of this, the electrolyte solution was progressively decomposed, and the reaction resistance was increased. By contrast, in example 3, the ABET specific surface area was relatively large. Therefore, it is considered that the surface of the graphite was excessively coated with the amorphous carbon. It is considered that in the case where the surface of the graphite was excessively coated with the amorphous carbon, the gap between the layers of the layer structure of the graphite was closed and the lithium ions did not easily enter the gap between the layers. It is presumed that as a result of this, the lithium ion acceptability was insufficient, and the lithium was deposited, and as a result, the reaction resistance was increased. It is seen from these results that there is an appropriate range of the amount of the amorphous carbon coating the graphite, and the ABET specific surface area is preferably usable as a parameter of the amount of the amorphous carbon.

It is seen from Table 1 that the reaction resistance is decreased in the case where as in examples 4 through 9, the average particle diameter (D₅₀) of the negative electrode active material is 7.2 μm or longer and 9.1 μm or shorter, the BET specific surface area of the negative electrode active material is 3.4 m²/g or larger and 4.5 m²/g or smaller, and the Raman peak intensity ratio (I_{D}/I_{G}) is 0.15 or higher and 0.23 or lower. It is considered that for such a negative electrode active material, the amount of the amorphous carbon coating the graphite is adjusted appropriately, and therefore, the reaction resistance is decreased.

While specific examples of the technology disclosed herein have been described in detail, the above description provides a mere example and does not limit the scope of the claims. The technology disclosed herein encompasses various modifications and alterations of the specific examples described above.

What is claimed is:

1. A method for producing a negative electrode active material containing amorphous carbon-coated graphite particles including graphite particles and amorphous carbon coating at least a part of a surface thereof, the method comprising the steps of:
preparing the graphite particles having a BET specific surface area of 10.3 m²/g or larger and 12.2 m²/g or smaller; and
coating at least a part of the surface of the graphite particles with the amorphous carbon,
wherein in the step of coating, at least the part of the surface of the graphite particles is coated with the amorphous carbon such that a value obtained by subtracting a BET specific surface area of the negative electrode active material from a BET specific surface area of the graphite particles is 6.9 m²/g or larger and 8.3 m²/g or smaller.

2. The method for producing the negative electrode active material according to claim 1, wherein the negative electrode active material has an average particle diameter (D₅₀), based on a volume-based particle diameter distribution by a laser diffraction and scattering method, of 7.2 μm or longer and 9.1 μm or shorter.

3. A negative electrode active material for a lithium ion secondary battery, the negative electrode active material comprising:
amorphous carbon-coated graphite particles having a surface, at least a part of which is coated with amorphous carbon,
wherein:
the negative electrode active material has an average particle diameter (D₅₀), based on a volume-based particle diameter distribution by a laser diffraction and scattering method, of 7.2 μm or longer and 9.1 μm or shorter,
the negative electrode active material has a BET specific surface area of 3.4 m²/g or larger and 4.5 m²/g or smaller, and
in a Raman spectrum measured by laser Raman spectroscopy, an intensity ratio (I_{D}/I_{G}) of an intensity I_{D} of a D peak appearing at a position of 1470 cm⁻¹ with respect to an intensity I_{G} of a G peak appearing at a position of 1580 cm⁻¹ is 0.15 or higher and 0.23 or lower.

4. The negative electrode active material according to claim 3, wherein the graphite particles include natural graphite.

5. A lithium ion secondary battery, comprising:
a positive electrode, a negative electrode, and a non-aqueous electrolyte,
wherein the negative electrode includes a negative electrode active material according to claim 3.
